(19) United States
(12) Patent Application Publication
(10) Pub. No.: US 2008/0244105 A1
(43) Pub. Date: Oct. 2, 2008

(54) ENHANCING PERFORMANCE OF INPUT-OUTPUT (I/O) COMPONENTS

(76) Inventors: Michael A. Rothman, Puyallup, WA (US); Vincent J. Zimmer, Federal Way, WA (US)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(21) Appl. No.: 11/691,670

(22) Filed: Mar. 27, 2007

(51) Int. Cl. G06F 3/01; G06F 9/455

(52) U.S. Cl. 710/13

(57) ABSTRACT

A computing platform may comprise a flash memory that may operate as a cache to the transactions targeting the hard disk. The flash memory may increase the speed of fulfilling the transactions (or reduce the latency) and may consume lesser power compared to the hard disk fulfilling the transactions. The latency and higher power consumption of the hard disk may be associated with the physically moving parts of the hard disk. A host device and a chipset may send the transactions to the flash memory if the I/O routing is enabled, which otherwise may be routed to the hard disk.

### BACKGROUND

A computing platform may comprise software, firmware, and hardware devices such as microprocessors, chipsets, and input-output (I/O) components. The I/O components may comprise hard disk drive, key-board, mouse, and other similar components. The performance of the hard disk drive (HDD) may, for example, refer to the speed at which the transaction targeted at the HDD are fulfilled and the power consumed by the HDD in fulfilling the transactions. The HDD may comprise physically moving parts such as magnetic or optical drive, which may cause latency in fulfilling the transactions targeting the HDD. Also, the HDD may consume more power due to the presence of moving parts.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates an embodiment of a computing platform 100.

FIG. 2 illustrates an embodiment of an operation of the computing platform, which may enhance the performance of I/O components.

### DETAILED DESCRIPTION

The following description describes enhancing the performance of I/O components. In the following description, numerous specific details such as logic implementations, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits, and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

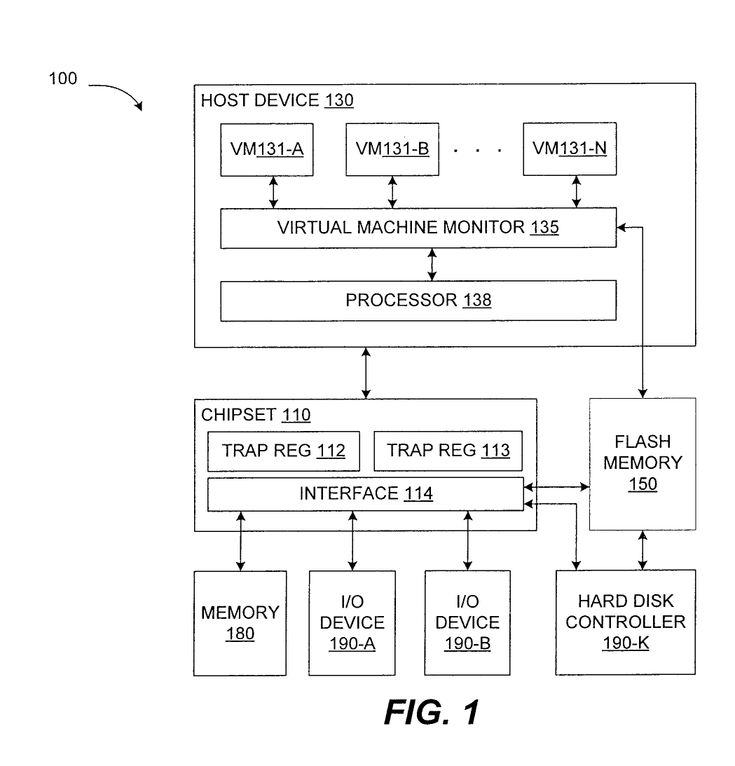

An embodiment of a computing platform 100 is illustrated in FIG. 1. The computing platform 100 may comprise a chipset 110, a host device 130, a flash memory 150, a memory 180, and one or more I/O devices 190-A, 190-B, and a hard disk controller 190-K.

The memory 180 may store data and/or software instructions that the host device 130 or any other device of the computing platform 100 may access and perform operations. The memory 180 may comprise one or more different types of memory devices such as, for example, DRAM (Dynamic Random Access Memory) devices, SDRAM (Synchronous DRAM) devices, DDR (Double Data Rate) SDRAM devices, or other volatile and/or non-volatile memory devices used in computer system 100.

The I/O devices 190 may comprise a key-board, mouse, a hard disk, and a monitor. In one embodiment, the hard disk may be coupled to the hard disk controller 190-K. The hard disk may comprise physically moving parts such as optical or magnetic drives. The physically moving components may be limited by the speed at which the parts may spin. Also, the power consumed by the hard disk comprising physically moving parts may be high.

The flash memory 150 may comprise devices of fast flash technology. In one embodiment, the flash memory 150 may comprise a NAND FLASH device. In one embodiment, the fast flash technology may support access speeds of 600 megabytes/sec (Mbps). The flash memory 150 may be coupled to the host device 130 and the chipset 110. In one embodiment, the flash memory 150 may be logically paired to the hard disk and may not be physically coupled to the hard disk. In one embodiment, the flash memory 150 may receive the transactions targeting the hard disk from one of the VMM 135 or the chipset 110 if the I/O routing is enabled. In one embodiment, the flash memory 150 may cache the transactions targeting the hard disk if the I/O routing is enabled. Since the flash memory 150 may operate at a higher speed and lower power compared to the hard disk, the performance of the I/O components may be enhanced. Such an approach may result in enhanced performance of the computing platform 100.

In one embodiment, the I/O routing may be enabled either by programming the chipset 110 or the host device 130.

The chipset 110 may comprise one or more integrated circuits or chips that couple the host device 130, the flash memory 150, the memory 180, and the I/O devices 190. In one embodiment, the chipset 110 may comprise controller hubs such as a memory controller hub and an I/O controller hub to, respectively, couple with the memory 180 and the I/O devices 190. In one embodiment, the chipset 110 may comprise an interface 114 through which the transactions are routed. The chipset 110 may receive data packets or units corresponding to a transaction generated by the I/O devices 190 and may forward the packets to the memory 180 and/or the host device 130.

Also, the chipset 110 may generate and transmit data units to the memory 180 and the I/O devices 190 on behalf of the host device 130. In one embodiment, the transactions generated by the host device 130 may be routed to the flash memory 150 if the I/O routing is enabled. In one embodiment, the chipset 110 may comprise trap register 112 and 113, which may be used to enable I/O routing. In one embodiment, the trap register 112 may represent ATC-APM Trapping Control Register (SATA-D31:F2) and the trap register 113 may represent ATC-APM Trapping Control Register (IDE-D31:F1) described in Sec. 12.1.40 and Sec 11.1.26, respectively, in Intel® I/O Controller Hub (ICH6) Family Datasheet.

In one embodiment, the trap register 112 may comprise bit [7:0] and bit-0, bit-1, bit-2, and bit-3 may represent a primary master trap (PMT), a primary slave trap (PST), a secondary master trap (SPT), and a secondary slave trap (SST) and bits [4 to 7] are reserved. In one embodiment, the bits [0-3] may be programmed with logic 0 or 1. In one embodiment, the bits [0-3] may be set to 1 and bits [4-7] may be set to ‘0’ to enable trapping on the primary and secondary masters and slaves. In one embodiment, the trap register 112 may be programmed to enable I/O routing for a Serial Advanced Technology Attachment (SATA) hard disk.

In one embodiment, the bit-0 (PMT) and bit-1 (PST) of the trap register 113 may be set to logic ‘1’ to, respectively, trap the master and slave. In one embodiment, the trap register 113 may be programmed to control the transactions targeted to Integrated Drive Electronics (IDE) hard disk.

The host device 130 may comprise one or more virtual machines 131-A to 131-N, a virtual machine monitor (VMM) 135, and a processor 138. The processor 138 may manage various resources and processes within the host device 130. In one embodiment, the processor 138 may represent Pentium®, Itanium®, or Core Duo® family of Intel® processors. In one embodiment, the processor 138 may support the VMM 135.

In one embodiment, a virtual machine may comprise software that mimics the performance of a hardware device. The virtual machines 131-A to 131-N may operate independent of the underlying hardware platform. In one embodiment, the virtual machine 131-A to 131-N may comprise user applications, device drivers, and operating system (OS) such as Windows®2000, Windows®XP, Linux, MacOS®, and UNIX® operating systems.

In one embodiment, the VMM 135 may hide the processor 138 from the virtual machines 131-A to 131-N. Thus, the VMM 135 may enable any application written for the virtual machines 131 to be operated on any of the hardware platform. In one embodiment, the VMM 135 may support operating systems (OS). In one embodiment, the VMM 135 may determine whether the I/O routing is enabled based on the routing enable signals provided by the device driver component of the virtual machines 131. In one embodiment, the routing enable signals may indicate that the VMM 135 may direct the transactions to the flash memory 150.

In one embodiment, the device drivers may comprise enlightened drivers, which may determine the presence of the VMM 135 in the system 100. The enlightened drivers may also determine the underlying access mechanism used by the operating system to send transactions to the hard disk controller 190-K. In one embodiment, the enlightened drivers may send the routing enable signals such as an alert signal to the VMM 135 if the operating system is intending to send a transaction to the hard disk controller 190-K. In one embodiment, the VMM 135 may set the routing parameters such as the destination address for each transaction to indicate that the transactions are to be routed to the cache memory 150. The VMM 135 may route the transactions to the flash memory 150.

In one embodiment, the I/O routing may be enabled by the platform configuration setting embedded in a platform setup routine, which may be stored in the platform basic input output system (BIOS). In one embodiment, the BIOS may launch the VMM 135 during the initialization of the computing platform 100.

In one embodiment, the enlightened device driver may initiate a VMCALL to alert the VMM 135 in response to the virtual machines 131 making an attempt to access the hard disk. In one embodiment, the VMM 135 may change the source/destination address of the transactions to represent the address of the flash memory 150.

In other embodiment, the VMM 135 may trap on the I/O ranges specified by the hard disk controller 190-K. The VMM 135 may monitor the accesses and may identify the accesses that intend to access data residing on the hard disk coupled to the controller 190-K. The VMM 135 may then route the accesses to the flash memory 150.

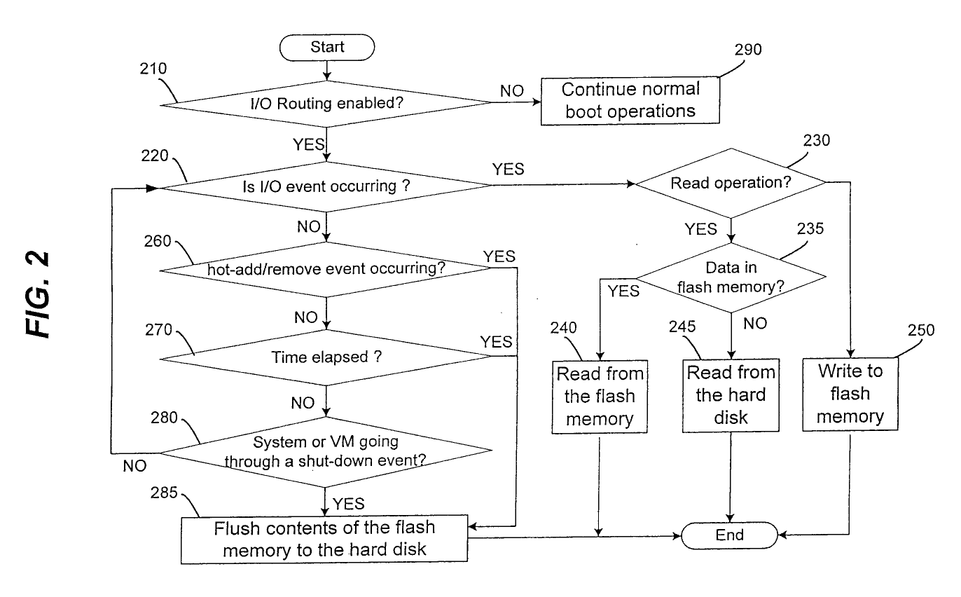

An embodiment of an operation of the computing system 100, which may enhance the performance of I/O components, is illustrated in FIG. 2. In block 210, the VMM 135 may determine if I/O routing is enabled by examining the signals sent by the enlightened driver of the virtual machine 131. Alternatively, the chipset 110 may determine if the I/O routing is enabled by examining the logic levels set on the bits 0, 1, 2, and 3 or bits 0 and 1 of the trap register 112 and 113 respectively. Control passes to block 215 if I/O routing is enabled and to block 290 otherwise.

In block 220, the VMM 135 may determine whether an I/O event is occurring and control passes to block 230 if the I/O event is occurring and to block 260 otherwise. In one embodiment, the VMM 135 may alert signals from the virtual machines 131 and based on the alert signals received the VMM 135 may determine that an I/O event is occurring. In block 230, the VMM 135 may determine if the I/O event is a read operation and control passes to block 235 if the I/O event is a read operation and to block 250 otherwise.

In block 235, the VMM 135 may determine if the data targeted by the read operation is in flash memory 150 and control passes to block 240 if the data targeted by the read is present in the flash memory 150 and to block 245 otherwise. In block 240, the VMM 135 may read the data from the flash memory 150. In block 245, the VMM 135 may read the data from the hard disk.

In block 250, the VMM 135 may write the data to the flash memory 150. In block 260, the VMM 135 may determine whether a hot add/remove event is occurring and control passes to block 270 if the hot add/remove event is not occurring and to block 285 otherwise. In block 270, the VMM 135 may determine whether pre-specified time duration has elapsed and control passes to block 280 if the time duration has not elapsed and to block 285 otherwise. In block 280, the VMM 135 may determine if the computing platform 100 or the VMs 131 is going through a shut-down and control passes to block 220 if the shut-down is not occurring and to block 285 otherwise. In block 285, the VMM 135 may flush the contents of the flash memory 150 to the hard disk.

Certain features of the invention have been described with reference to example embodiments. However, the description is not intended to be construed in a limiting sense. Various modifications of the example embodiments, as well as other embodiments of the invention, which are apparent to persons skilled in the art to which the invention pertains are deemed to lie within the spirit and scope of the invention.

What is claimed is:

1. A method comprising:
determining whether input-output routing is enabled,
routing transactions to a cache memory if the input-output routing is enabled, wherein the cache memory is logically coupled to a hard disk, and
routing the transactions to the hard disk drive if the input-output routing is not enabled.

2. The method of claim 1 determining whether the input-output routing is enabled further comprises:
checking the contents of a first set of bits of a first register, and
routing the transactions to the cache memory if the first set of bits of the first register is set,
wherein the hard disk is of serial advanced technology attachment type.

3. The method of claim 2 determining whether the input-output routing is enabled further comprises:
checking the contents of a first set of bits of a second register, and
routing the transactions to the cache memory if the first set of bits of the second register is set,
wherein the hard disk is of integrated device electronics type.

4. The method of claim 1 determining whether the input-output routing is enabled further comprises:
receiving a routing enable signal from a virtual machine, wherein the routing enable signal is generated by the virtual machine if the operating system is accessing the hard disk, and
setting the routing parameters to indicate that the transactions are to be routed to the cache memory.

5. The method of claim 1, wherein the cache memory comprises NAND fast flash technology.

6. The method of claim 1 routing transactions to the cache memory further comprises reading data from the cache memory if the transaction is a read operation and if the data is present in the cache memory.

7. The method of claim 6 routing transactions to the cache memory further comprises writing data to the cache memory if the transaction is not the read operation.

8. The method of claim 7 comprises flushing the transactions from the cache memory to the hard disk if a pre-specified time is elapsed.

9. The method of claim 1 routing transactions to the hard disk further comprises reading data from the hard disk if the transaction is a read operation and if the data is present in the hard disk.

10. An apparatus comprising:
a hard disk,
a cache memory, wherein the cache memory is logically coupled to the hard disk,
a chipset coupled to the hard disk and the cache memory, and
a host device coupled to chipset to determine whether input-output routing is enabled, to route transactions to the cache memory if the input-output routing is enabled, and to route the transactions to the hard disk drive if the input-output routing is not enabled.

11. The apparatus of claim 10 the chipset further comprises:
a first register comprising a first set of bits, wherein the input-output routing is enabled if the first set of bits are set, and
an interface to route the transactions to the cache memory if the first set of bits of the first register is set,
wherein the hard disk is of serial advanced technology attachment type.

12. The apparatus of claim 11 the chipset further comprises:
a second register comprising a first set of bits, wherein the input-output routing is enabled if the first set of bits are set, and
the interface to route the transactions to the cache memory if the first set of bits of the second register is set,
wherein the hard disk is of integrated device electronics type.

13. The apparatus of claim 10 the host device further comprises:
a virtual machine to generate a routing enable signal if the operating system is accessing the hard disk, and
a virtual machine monitor to set the routing parameters to indicate that the transactions are to be routed to the cache memory in response to receiving the routing enable signal.

14. The apparatus of claim 10, wherein the cache memory comprises NAND fast flash technology.

15. The apparatus of claim 10, wherein the host device is to read data from the cache memory if the transaction is a read operation and if the data is present in the cache memory.

16. The apparatus of claim 15, wherein the host device is to write data to the cache memory if the transaction is not the read operation.

17. The apparatus of claim 16, wherein the host device is to flush the transactions from the cache memory to the hard disk if a pre-specified time is elapsed.

18. The apparatus of claim 10, wherein the host device is to read data from the hard disk if the transaction is a read operation and if the data is present in the hard disk.
